(19) United States
(12) Patent Application Publication
(10) Pub. No.: US 2022/0292388 A1
(43) Pub. Date: Sep. 15, 2022

(54) MACHINE LEARNING MOBILE DEVICE LOCALIZATION

(71) Applicant: FORD GLOBAL TECHNOLOGIES, LLC, Dearborn, MI (US)

(72) Inventors: Vivekanandh ELANGOVAN, Canton, MI (US); Ali HASSANI, Ann Arbor, MI (US); Hemanth Yadav ARADHYULA, Farmington Hills, MI (US); Hamid M. GOLGIRI, Livonia, MI (US); John Robert VAN WIEMEERSCH, Novi, MI (US)

(21) Appl. No.: 17/196,544

(22) Filed: Mar. 9, 2021

(51) Int. Cl. G06N 20/00; H04W 4/029; G07C 5/00

(52) U.S. Cl. CPC G06N 20/00; H04W 4/029; G07C 5/008; B60R 2325/101; B60R 25/24

(57) ABSTRACT

A machine-learning localization scheme is provided. Calibration data is received from a plurality of vehicles, the calibration data including wireless data indicative of locations of mobile devices within the plurality of vehicles, ground truth data with respect to the locations of the mobile devices, and contextual information with respect to one or more of operating system versions of the mobile devices or battery levels of the mobile devices. A machine-learning model is trained using the wireless data and the contextual information as inputs and the ground truth data as output. Responsive to an error rate for the machine-learning model being within an error target, the machine-learning model is provided to the plurality of vehicles.

### TECHNICAL FIELD

Aspects of the disclosure relate to use of machine learning techniques to improve localization of mobile devices.

### BACKGROUND

Passive Entry and Passive Start (PEPS) systems allow customers to enter the vehicle and drive away without having to physically handle a key. Phone-as-a-key (PaaK) allows the use of a smartphone to act as both a passive key and to provide traditional key fob functions, such as unlock, lock, remote start, and lift gate access. PaaK may be implemented using Bluetooth Low Energy (BLE), which is an inbuilt technology in most smartphones on the market. Ultra-Wide Band (UWB) may be used for phone localization to provide better localization compared to BLE localization approaches.

### SUMMARY

In a first illustrative embodiment, a system for implementing a machine-learning localization scheme is provided. The system includes a processor programmed to receive calibration data from a plurality of vehicles, the calibration data including wireless data indicative of locations of mobile devices within the plurality of vehicles, ground truth data with respect to the locations of the mobile devices, and contextual information with respect to the mobile devices; train a machine-learning model using the wireless data and the contextual information as inputs and the ground truth data as output; and responsive to an error rate for the machine-learning model being within an error target, provide the machine-learning model to the plurality of vehicles.

In a second illustrative embodiment, a method for machine-learning localization scheme is provided. Calibration data is received from a plurality of vehicles, the calibration data including wireless data indicative of locations of mobile devices within the plurality of vehicles, ground truth data with respect to the locations of the mobile devices, and contextual information with respect to the mobile devices. A machine-learning model is trained using the wireless data and the contextual information as inputs and the ground truth data as output. Responsive to an error rate for the machine-learning model being within an error target, the machine-learning model is provided to the plurality of vehicles.

In a third illustrative embodiment, a non-transitory computer-readable medium includes instructions that, when executed by a processor, cause the processor to perform operations including to receive calibration data from a plurality of vehicles, the calibration data including wireless data indicative of locations of mobile devices within the plurality of vehicles, ground truth data with respect to the locations of the mobile devices, and contextual information with respect to the mobile devices; train a machine-learning model using the wireless data and the contextual information as inputs and the ground truth data as output; and responsive to an error rate for the machine-learning model being within an error target, provide the machine-learning model to the plurality of vehicles.

### BRIEF DESCRIPTION OF THE DRAWINGS

FIG. 1 illustrates an example system including a mobile device configured for implementing a machine-learning localization scheme;

FIG. 2 illustrates an example diagram illustrating seating zones to which mobile devices may be assigned;

FIG. 3 dissertates a client-server system for the updating of a machine-learning model 302 based on data received from a fleet of vehicles;

FIG. 4 illustrates an example process for implementing a machine-learning localization scheme; and

FIG. 5 illustrates an example of a computing device for implementing aspects of the machine-learning localization scheme.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Some tasks within a vehicle environment require knowledge about where a person is in relation to the vehicle. In an example, a welcome zone for a vehicle may be activated as a user approaches the vehicle, causing the vehicle lights to be turned on. In another example, a passive entry zone for a vehicle may be activated as a user approaches closer to the vehicle, causing the vehicle doors (or a door closest to the user) to be unlocked. In yet a further example, if a person has a mobile device application to control climate settings, the vehicle or application may attempt to determine the seating zone within the vehicle for which to adjust the settings. In some vehicles, sensors triangulate the mobile device to identify the location of the mobile device. For instance, BLE localization may be performed using received signal strength indication (RSSI) data measured by various components packaged around the vehicle. When identifying the zone corresponding to the location of the mobile device, the RSSI values may be compared against pre-established thresholds to determine the correct zone.

However, the BLE RSSI values may change significantly depending upon the position of the mobile device in the vehicle (or whether the device is held in a pant pocket, purse, backpack, etc.). The BLE RSSI values may also vary according to smartphone design. These variables may cause the seating zone of the user to be miscalculated, potentially leading to confusion about the performance of the system. Moreover, it may be difficult for a vehicle manufacturer to uniformly calibrate the system for consistent performance across various environments due to the changing variety of mobile devices and use cases.

As explained in detail below, a machine-learning approach may be utilized to improve localization of mobile devices. Calibration data is received from a plurality of vehicles. The calibration data includes wireless data indicative of locations of the mobile devices within the plurality of vehicles, ground truth data with respect to the locations of the mobile devices, and contextual information with respect to one or more of operating system versions of the mobile devices or battery levels of the mobile devices. A machine-learning model is trained using the wireless data and the contextual information as inputs and the ground truth data as output. Responsive to an error rate for the machine-learning model being within an error target, the machine-learning model is provided to the plurality of vehicles. Further aspects of the disclosure are discussed in detail herein.

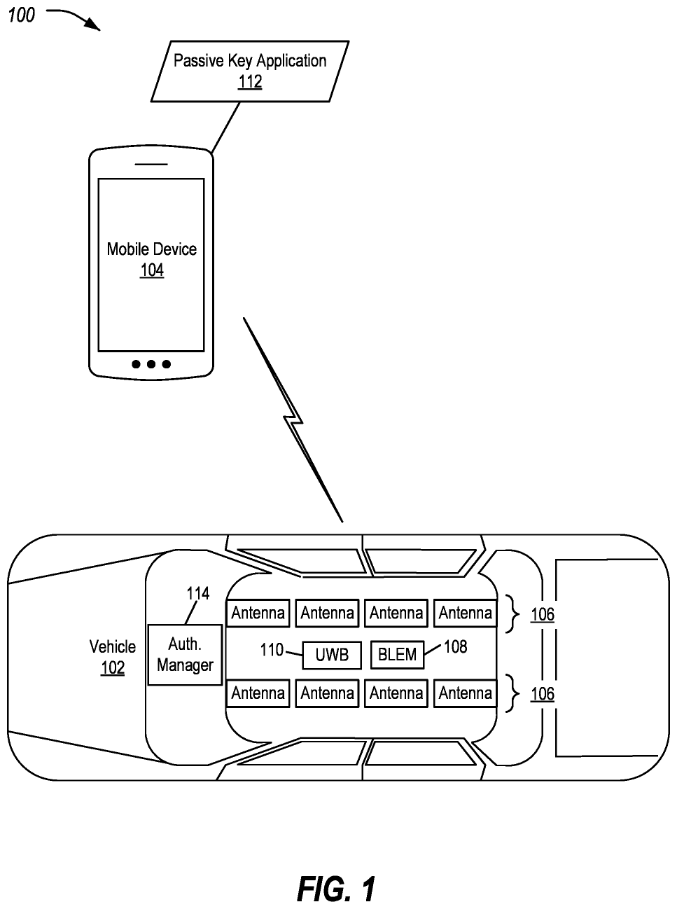

FIG. 1 illustrates an example system 100 including a mobile device 104 configured for implementing a machine-learning localization scheme. The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle powered by both an internal combustion engine and one or more electric motors, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The mobile device 104 may be any of various types of portable computing device, such as cellular phones, tablet computers, smart watches, laptop computers, portable music players, key fob, or other such devices brought into the vehicle 102 and having processing and communications capabilities. The mobile device 104 may include one or more processors configured to execute computer instructions, and a storage medium on which the computer-executable instructions and/or data may be maintained. The mobile device 104 may further include various wireless transceivers, such as a BLUETOOTH, BLE, Wi-Fi, and/or UWB transceivers.

The vehicle 102 may include an array of antennas 106 configured to facilitate communication between the mobile device 104 and the vehicle 102. For instance, a plurality of BLE transceivers may be connected to the antennas 106 to form a BLE array that may be used to triangulate or otherwise detect the location of the mobile device 104. The BLE transceivers may be controlled by a BLE module (BLEM) 108, which may include a memory and a processor programmed to send and receive messaging between the mobile device 104 and the vehicle 102 (e.g., to provide for the performance of challenge-response sequences and/or to receive commands from the vehicle 102). In an example, a key fob may connect to the antenna 106 of the closest-detected BLE transceiver to facilitate communication with the BLEM 108 of the vehicle 102. As shown the vehicle 102 includes an array of eight antenna 106 about the perimeter of the vehicle 102 cabin, but it should be noted that implementations may include more, fewer, and/or differently located transceivers and/or antennas.

The mobile device 104 may also include a display configured to provide a user interface to a user. In some examples, the display may be touch-sensitive, and may be further configured to receive input from the user. Additionally, a passive key application 112 may include instructions that, when executed by the one or more processors of the mobile device 104, cause the mobile device 104 to perform operations to facilitate access to the vehicle 102. In an example, the passive key application 112 may cause the mobile device 104 to display a user interface to the display including controls like those of a key fob (e.g., lock, unlock, start, etc.). In another example, the passive key application 112 may cause the mobile device 104 to interact as a passive entry device with the vehicle 102, providing presence information to the BLEM 108 that allows the vehicle 102 to detect that an authorized user of the vehicle 102 is nearby. By executing the passive key application 112 to control communication of the mobile device 104 with the BLEM 108 of the vehicle 102, the mobile device 104 may be used to unlock, start, or otherwise access the vehicle 102.

The passive key application 112 may allow for the authentication of the mobile device 104 to the vehicle 102 using an authentication manager 114 of the vehicle 102. The authentication manager 114 may be a controller of the vehicle 102 that is in communication with the BLEM 108, as well as with other components of the vehicle 102, such as door locks or vehicle ignition interlock. The authentication of the mobile device 104 to vehicles 102 may utilize a PaaK feature implementation, ensuring a secure connection between the user mobile device 104 and a vehicle connectivity module (such as the BLEM 108), whereby the user position can be localized utilizing the BLE transceiver antennas 106. For instance, the authentication manager 114 may confirm the location of the mobile device 104 as local to the vehicle 102, and/or may perform relay attack prevention according to ToF and/or the location determination of the mobile device 104.

Some vehicles 102 may further implement additional protocols, such as UWB capability along with BLE for localization. As shown, the vehicle 102 further includes UWB controller 110 configured to utilize the antennas 106 to send and receive messaging between the mobile device 104 and the vehicle 102. As compared to BLE, UWB can provide for more precise location determination. For instance, UWB can measure distance and location to an accuracy of on the order of 5 to 10 cm, while. Wi-Fi, BLUETOOTH, and other narrowband radio systems typically reach an accuracy on the order of meters.

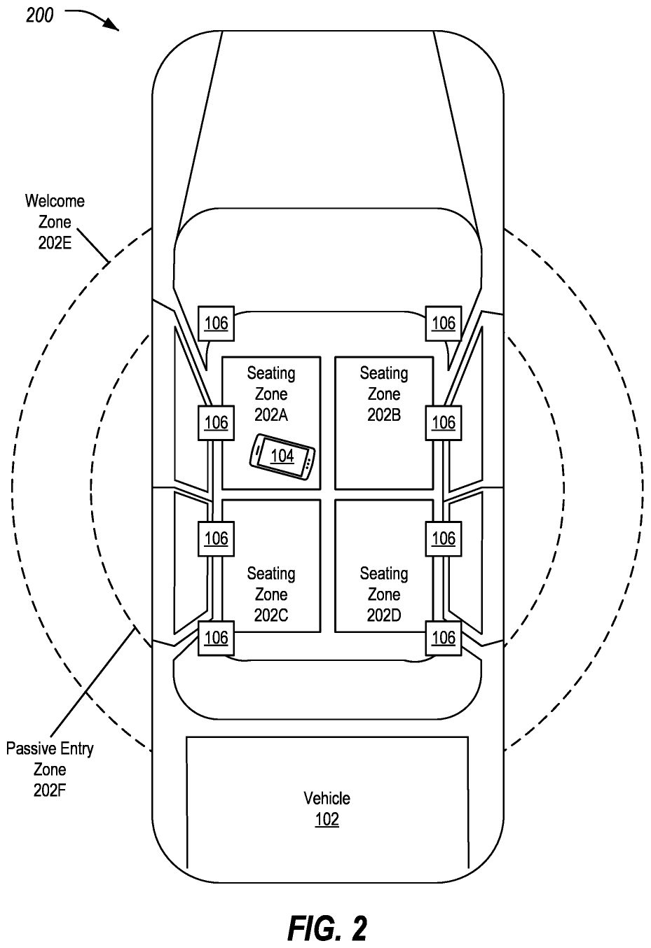

FIG. 2 illustrates an example diagram 200 illustrating zones 202 to which mobile devices 104 may be assigned. As shown, the vehicle 102 interior is divided into four seating zones 202, where each seating zone 202 is associated with a seating position within the vehicle 102 interior. As shown, the front row of the illustrated vehicle 102 includes a first zone 202A associated with the driver seating position, and a second zone 202B associated with a front passenger seating position. The second row of the illustrated vehicle 102 includes a third zone 202C associated with a driver-side rear seating position and a fourth zone 202D associated with a passenger-side rear seating position. It should be noted that the illustrated diagram 200 is merely an example, and more, fewer, and/or differently located seating zones 202 may be used.

Moreover, the mobile device 104 may also be assigned to a zone 202 external to the vehicle 102. For instance, a welcome zone 202E for the vehicle 102 may be defined as a first distance from the vehicle 102, such that if the user is within the welcome zone 202E the vehicle 102 lights may be turned on or other aspects of the vehicle 102 may be activated. In another example, a passive entry zone 202F for the vehicle 102 may be defined as a second, closer distance to the vehicle 102, such that if the user is within the passive entry zone 202F, vehicle 102 doors (or the door closest to the user) may be unlocked.

The mobile devices 104 may communicate with the antennas 106 supporting BLE to allow the vehicle 102 to capture RSSI information provided via the BLE protocol. The assignment of mobile devices 104 to seating zones 202 may be performed based on this captured information transmitted between the mobile devices 104 and the antennas 106. Once the mobile devices 104 is assigned to a seating zone 202, the passive key application 112 may allow the user to control radio, climate, and/or other vehicle settings. As illustrated, the mobile device 104 is located in the seating zone 202A and may be used to control settings in that seating zone 202.

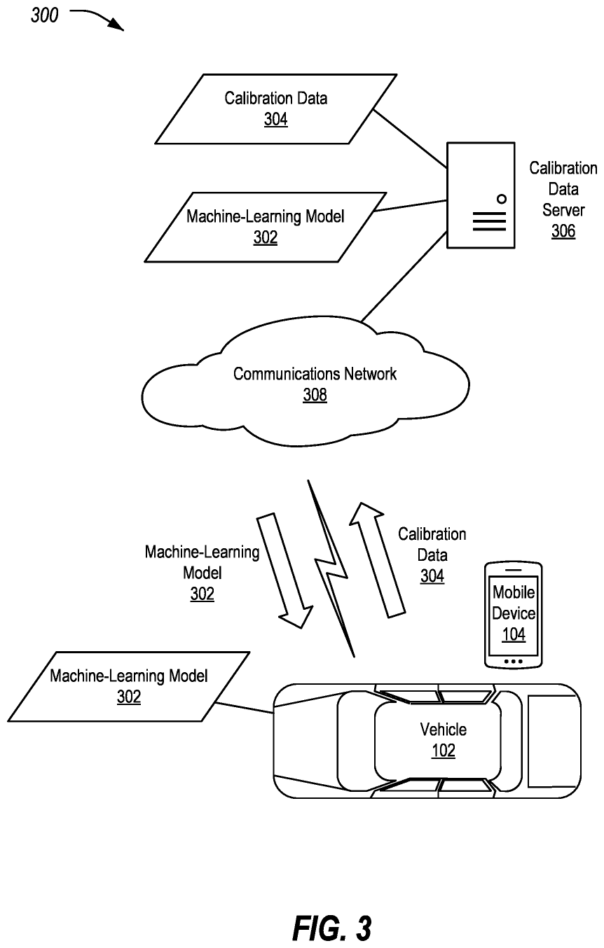

FIG. 3 illustrates a client-server system for the updating of a machine-learning model 302 based on data received from a fleet of vehicles 102. When used at runtime, the machine-learning model 302 may receive the BLE RSSI data as input and may provide a designation of the seating zone 202 as an output. During a training phase, the machine-learning model 302 may receive BLE RSSI data from mobile devices 104, as well as the ground truth seating zone 202 location of the mobile devices 104. This allows the machine-learning model 302 to update its coefficients with values that allow the machine-learning model 302 to predict the seating zone 202 of the mobile device 104 from the RSSI data when the ground truth isn't available.

As noted above, some vehicles 102 may support multiple protocols, such as BLE and UWB. In such a vehicle 102, data for both UWB time of Flight (ToF) data and BLE RSSI data can be collected on the same vehicle 102 for the same mobile device 104. In such an example, the machine-learning model 302 may utilize the UWB data as the ground truth information for training the machine-learning model 302 to determine the correct zone. This zone may include, in an example, seating zone 202. This zone may additionally or alternately include other zones, such as passive entry zone in which the vehicle 102 may be unlocked, welcome zone in which the vehicle 102 lights may be activated as the user approaches, and/or any other zone associated with PaaK functionality. This allows the machine-learning model 302 to use the UWB data learn the variance in the BLE RSSI data.

The vehicles 102 may be configured to send calibration data 304 to the calibration data server 306. In one example, the machine-learning model 302 may be trained on a calibration data server 306. In such an example, the calibration data server 306 may receive BLE and UWB data over a communications network 308 from the vehicle 102 as well as from other vehicles 102. This data from the vehicles 102 may be aggregated by the calibration data server 306 and used as a training set for the machine-learning model 302. By training the machine-learning model 302 using calibration data 304 including UWB data from many vehicles 102, the UWB data may be used to compensate for BLE offsets even on vehicles 102 that do not implement UWB.

The calibration data 304 may also include information pertaining to proximity to the user. For example, label annotations for the calibration data 304 may indicate where the mobile device 104 is located on the user, if it is in free space (e.g. a cupholder), or if it encapsulated in storage (e.g. backpack), as the interference will impact the RSSI. These label annotations may be queried from the user, in an example, to allow for the annotations to be determined. In other examples, the label annotations may be inferred based on other information. For instance, it may be inferred that the mobile device 104 is in a cupholder based on proximity of the mobile device 104 to a cupholder sensor. Or, it may be inferred that the mobile device 104 is in a bag based on presence of reflections or of a lowered overall signal strength for the mobile device 104 in comparison to an average signal strength for the model of the mobile device 104 in comparison with time of flight distance measurements, etc.

Regardless of the source of the annotations, the annotated data may be used to yield multiple context-based machine-learning models 302. For instance, a first machine-learning model 302 may be used to determine a type of interference the device is experience. This may utilize a forensics approach, whereby noise profile analysis is used to determine the type of interference. Various materials absorb and reflect wireless waves in predictable fashions; the impact of these absorptions and reflections can then be detected in the noise profile of the signal. Examples of this may include measuring secondary harmonics to determine the presence of reflections and using frequency analysis to determine which expected signals have been absorbed. This noise profile can then be used to predict the surrounding interference. Based upon the determined interference state, a machine-learning model 302 specifically trained for that type of context can then be applied to measure position more precisely.

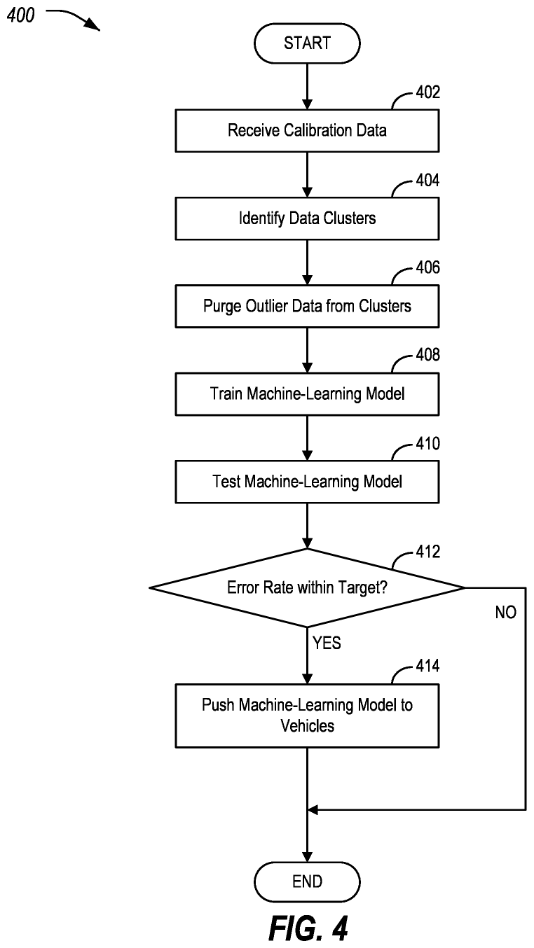

FIG. 4 illustrates an example process 400 for implementing a machine-learning localization scheme. In an example, aspects of the process 400 may be implemented by the calibration data server 306 in the context of the systems 100 and 300.

At operation 402, the calibration data server 306 receives calibration data 304 from one or more vehicles 102. For instance, the calibration data 304 may include RSSI values, UWB ToF values, and/or other location-determining information (e.g., captured from the mobile devices 104 and provided to the vehicles 102, captured by the vehicles 102 based on the mobile devices 104, etc.). In some examples, the calibration data server 306 may, in addition to receiving the BLE RSSI for the specific model of mobile device 104, also receive additional contextual information regarding the mobile device 104. This contextual information may include, as some nonlimiting examples, mobile device 104 model, operating system version, mobile device 104 battery level information, offset with respect to signal strength for the mobile device 104, etc.

At operation 404, the calibration data server 306 identifies data clusters from the received calibration data 304. In an example, the calibration data server 306 may cluster the calibration data 304 according to one or more of the device models of the mobile device 104, the operating system version of the mobile device 104, and/or the battery charge level of the mobile device 104. This clustering information may be useful as further inputs to the machine-learning model 302 in addition to the RSSI values.

In an example, mobile device 104 manufacturers may adjust mobile device 104 wireless output power over time to compensate or mitigate for mobile device 104 feature concerns. For instance, a manufacturer may elect to reduce BLE output power if the mobile device 104 battery is below a threshold amount of charge to preserve cellular call capability. If so, parameters for such mobile devices 104 may not be directly comparable to data from the same mobile devices 104 when charged.

At operation 406, the calibration data server 306 purges outlier data. In one example, the calibration data server 306 may purge data according to the clustered data, such as removing outlier data elements that appear to be erroneous data, and/or that have RSSI that is more than two standard deviations away from the mean of the data.

In another example, if the battery level is below a certain threshold (e.g., 15%), the calibration data server 306 may exclude the BLE RSSI values from the learning of the machine-learning model 302. This may be done because such values may be artificially low for reasons such as the operating system actions mentioned above. Or, this data may be used, but be flagged as being received from a mobile device 104 having a low charge level. If so flagged, then the machine-learning model 302 may be configured to automatically account for instances where the mobile device 104 is functioning in a low-power mode.

In some examples, the calibration data server 306 may discard collected RSSI data if the UWB measurements suggest a relay attack attempt in progress. This data may be discarded because relay attack systems can amplify the BLE signal, which would not be comparable to that of a genuine mobile device 104 interaction. Ignoring such data may avoid introducing error into the machine-learning model 302 as compared to if such amplified measurements were used in the training. For instance, the calibration data server 306 may, if the mobile device 104 is deemed to be outside of a valid PEPS zone as detected according to the UWB ToF value, suspend the BLE RSSI calibration to avoid performing machine learning using a false amplified or attenuated BLE RSSI values.

In some examples, if the mobile device 104 is in a valid PEPS zone as determined by UWB ToF, it may be difficult for the calibration data server 306 to determine whether BLE amplification is being performed (e.g., depending on the amplifier location), which may cause the calibration data server 306 to calibrate off a false signal. However, unless the amplifier is located close to the mobile device 104, the vehicle 102 may be able to detect the amplifier by examining the RSSI level as seen by each of the antennas 106 of the vehicle 102 for RSSI values that are outliers for the location indicated by the UWB ToF data. This may allow the vehicle 102 to recognize an in-zone BLE amplification in in progress and suspend use of that data in the calibration.

At operation 408, the calibration data server 306 trains the machine-learning model 302. In an example, the RSSI data received from the vehicles 102 and the UWB ground truth information may be applied to the machine-learning model 302. Thus, the machine-learning model 302 may be updated with coefficients that allow the machine-learning model 302 to predict the zone (e.g., seating zone 202, passive entry zone, welcome zone, etc.) of the mobile device 104 from the RSSI data, even when the ground truth isn't known.

At operation 410, the calibration data server 306 tests the machine-learning model 302 to ensure that the machine-learning model 302 operates correctly. In an example, the machine-learning model 302 may be tested using a subset of the parameter data that was not used in the training at operation 408. In another example, machine-learning model 302 may be tested using another training data set separate from the data captured from the vehicles 102. In still another example, the machine-learning model 302 may be provided to a test set of the vehicles 102, where those vehicles 102 may then report back to the calibration data server 306 whether the machine-learning model 302 performs better or worse at detection than a previous machine-learning model 302 used by the vehicles 102.

At operation 412, the calibration data server 306 determines whether the error rate is within an error target. In an example, the calibration data server 306 may accept the machine-learning model 302 as within the error target whenever a new local model achieves the target error rate. In another example, the calibration data server 306 may accept the machine-learning model 302 as within the error target responsive to the machine-learning model 302 achieving correct results in at least a predefined percentage of instances (e.g., 95%, 99%, etc.). In yet another example, the calibration data server 306 may accept the machine-learning model 302 responsive to a predefined number or percentage of vehicles 102 reflecting a satisfactorily low predefined error rate target (e.g., the new machine-learning model 302 performs better than the one it replaces, achieved correct results in at least a predefined percentage of instances, etc.).

If the error rate is within the target, control passes to operation 414 to provide the machine-learning model 302 to the vehicles 102. After operation 414, the process 400 ends. If not, then the machine-learning model 302 is not rolled out. The calibration data server 306 may, for example, await further data at operation 402 and again perform the process 400 using that additional data. In some examples, the process 400 is performed continuously or periodically by the calibration data server 306.

Variations on the process 400 are possible. For instance, a federated learning approach may also be applied to optimize training performance. In such an approach, each vehicle 102 may locally train a machine-learning model 302 based on UWB and BLE data local to the vehicle 102, to allow for parameters of the machine-learning model 302 to be iteratively updated. Responsive to a new set of parameters of the machine-learning model 302 being computed by the vehicle 102, these parameters may be transmitted from the vehicle 102 to the calibration data server 306 for analysis. In some examples, the calibration data server 306 may average out the machine-learning model 302 parameters for vehicles 102 that achieve the error rate target and update the global machine-learning model 302 accordingly. In other examples, the calibration data server 306 may combine, cluster, and utilize the data from the vehicles 102 that achieve the error rate target to construct and roll out an improved machine-learning model 302 using the data from the multiple vehicles 102.

In another variation, reinforcement learning can be applied to intelligently determine machine-learning model 302 changes. A reward function may be constructed by performing a secondary localization check. For instance, the secondary localization check may include comparing the BLE-predicted location against an extra UWB challenge each time the confidence the is low. Based upon the similarity score to the UWB data, the machine-learning model 302 may accordingly be reinforced or updated to account for new variations.

It should also be noted that the aforementioned techniques are not limited to use of UWB to assist BLE, and approaches may be performed using other protocols. In an example, BLE high accuracy distance measurement (HADM) algorithms nay be used to provide a distance measurement using BLE that may additionally or alternately be used to determine ground truth. In another example, WiFi ToF data may additionally or alternately be used. In yet a further example, UWB phase data may additionally or alternately be used.

In another example, BLE phase measurement may be used as a source of location information. As with UWB ToF, BLE phase measurement may be used to measure the variance in the BLE RSSI data by calculating the phase difference between each channel and estimating the distance from the source to the receiver. Based on the distance calculation from phase measurement variance in the RSSI data may be compensated for. By using this approach, variance in the BLE RSSI data may be reduced, thereby improving prediction accuracy.

In yet another example, BLE round trip time may be used as a source of location information. BLE round trip time may be also used to measure variance in BLE RSSI data. The BLE round trip time calculates time that a signal takes to travel from a source device to a destination device and back from the destination device to the source device. Based on the measured time elapsed, a distance may be inferred using the speed of light as the propagation speed of the radio frequency (RF) signal. Based on the distance calculation from BLE Round trip time, variance in the RSSI data may be compensated for.

In yet a further example, Wi-Fi ToF may be used as a source of location information. Wi-Fi time of flight may be used similar to BLE round trip time, but with a higher accuracy which may increase prediction accuracy of the BLE RSSI algorithm.

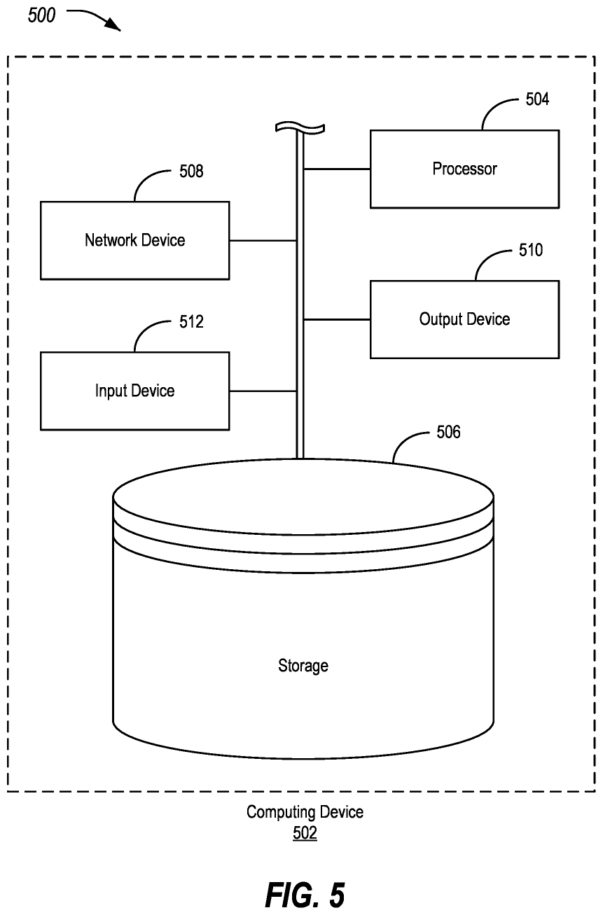

FIG. 5 illustrates an example 500 of a computing device 502 for implementing aspects of the machine-learning localization scheme. Referring to FIG. 5, and with reference to FIGS. 1-4, the vehicle 102, mobile device 104, and calibration data server 306 may be examples of such computing devices 502. As shown, the computing device 502 includes a processor 504 that is operatively connected to a storage 506, a network device 508, an output device 510, and an input device 512. It should be noted that this is merely an example, and computing devices 502 with more, fewer, or different components may be used.

The processor 504 may include one or more integrated circuits that implement the functionality of a central processing unit (CPU) and/or graphics processing unit (GPU). In some examples, the processors 504 are a system on a chip (SoC) that integrates the functionality of the CPU and GPU. The SoC may optionally include other components such as, for example, the storage 506 and the network device 508 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 504 executes stored program instructions that are retrieved from the storage 506. The stored program instructions, accordingly, include software that controls the operation of the processors 504 to perform the operations described herein. The storage 506 may include both non-volatile memory and volatile memory devices. The non-volatile memory includes solid-state memories, such as NAND flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 510. The output device 510 may include a graphical or visual display device, such as an electronic display screen, projector, printer, or any other suitable device that reproduces a graphical display. As another example, the output device 510 may include an audio device, such as a loudspeaker or headphone. As yet a further example, the output device 510 may include a tactile device, such as a mechanically raiseable device that may, in an example, be configured to display braille or another physical output that may be touched to provide information to a user.

The input device 512 may include any of various devices that enable the computing device 502 to receive control input from users. Examples of suitable input devices that receive human interface inputs may include keyboards, mice, trackballs, touchscreens, voice input devices, graphics tablets, and the like.

The network devices 508 may each include any of various devices that enable the vehicles 102, mobile devices 104, and/or calibration data server 306 to send and/or receive data from external devices over networks. Examples of suitable network devices 508 include an Ethernet interface, a Wi-Fi transceiver, a cellular transceiver, or a BLUETOOTH or BLE transceiver, UWB transceiver, or other network adapter or peripheral interconnection device that receives data from another computer or external data storage device, which may be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for implementing a machine-learning localization scheme comprising:
a processor, programmed to
receive calibration data from a plurality of vehicles, the calibration data including wireless data indicative of locations of mobile devices within the plurality of vehicles, ground truth data with respect to the locations of the mobile devices, and contextual information with respect to the mobile devices;
train a machine-learning model using the wireless data and the contextual information as inputs and the ground truth data as output; and
responsive to an error rate for the machine-learning model being within an error target, provide the machine-learning model to the plurality of vehicles.

2. The system of claim 1, wherein the processor is further programmed to:
identify data clusters in the calibration data according to the contextual information;
purge outlier data elements that are outliers with respect to the identified data clusters; and
train the machine-learning model according to the calibration data, as purged.

3. The system of claim 1, wherein the processor is further programmed to test the machine-learning model using test data to determine the error rate for the machine-learning model.

4. The system of claim 3, wherein the test data is a subset of the calibration data that is excluded from use in training the machine-learning model.

5. The system of claim 3, wherein the processor is further programmed to determine the error rate for the machine-learning model as being within the error target responsive to the machine-learning model achieving correct results in at least a predefined percentage of the test data.

6. The system of claim 1, wherein the processor is further programmed to:
send the machine-learning model to a test subset of the plurality of vehicles; and
determine the error rate to be within the error target responsive to receipt, from the test subset of the plurality of vehicles, of test information indicative of the machine-learning model performing more accurately at determining of the locations of the mobile devices as compared to a previous machine-learning model used by the test subset of the plurality of vehicles.

7. The system of claim 1, wherein the wireless data is BLUETOOTH RSSI information, and the ground truth data is UWB ToF data.

8. The system of claim 1, wherein the wireless data is BLUETOOTH RSSI information, and the ground truth data is BLE high accuracy distance measurement data.

9. The system of claim 1, wherein the ground truth data is one or more of UWB phasing data or Wi-Fi ToF data.

10. The system of claim 1, wherein the contextual information includes one or more of operating system versions of the mobile devices or battery levels of the mobile devices.

11. The system of claim 1, wherein the contextual information includes antenna characteristics defining offsets with respect to signal strengths for the mobile devices.

12. A method for implementing a machine-learning localization scheme comprising:
receiving calibration data from a plurality of vehicles, the calibration data including wireless data indicative of locations of mobile devices within the plurality of vehicles, ground truth data with respect to the locations of the mobile devices, and contextual information with respect to the mobile devices;
training a machine-learning model using the wireless data and the contextual information as inputs and the ground truth data as output; and
responsive to an error rate for the machine-learning model being within an error target, providing the machine-learning model to the plurality of vehicles.

13. The method of claim 12, further comprising:
identifying data clusters in the calibration data according to the contextual information;
purging outlier data elements that are outliers with respect to the identified data clusters; and
training the machine-learning model according to the calibration data, as purged.

14. The method of claim 12, further comprising testing the machine-learning model using test data to determine the error rate for the machine-learning model.

15. The method of claim 14, further comprising determining the error rate for the machine-learning model as being within the error target responsive to the machine-learning model achieving correct results in at least a predefined percentage of the test data.

16. The method of claim 12, further comprising:
sending the machine-learning model to a test subset of the plurality of vehicles; and
determining the error rate to be within the error target responsive to receipt, from the test subset of the plurality of vehicles, of test information indicative of the machine-learning model performing more accurately at determining of the locations of the mobile devices as compared to a previous machine-learning model used by the test subset of the plurality of vehicles.

17. A non-transitory computer-readable medium comprising instructions that, when executed by a processor, cause the processor to perform operations including to:
receive calibration data from a plurality of vehicles, the calibration data including wireless data indicative of locations of a mobile devices within the plurality of vehicles, ground truth data with respect to the locations of the mobile devices, and contextual information with respect to the mobile devices;
train a machine-learning model using the wireless data and the contextual information as inputs and the ground truth data as output; and
responsive to an error rate for the machine-learning model being within an error target, provide the machine-learning model to the plurality of vehicles.

18. The medium of claim 17, further comprising instructions that, when executed by the processor, cause the processor to:
identify data clusters in the calibration data according to the contextual information;
purge outlier data elements that are outliers with respect to the identified data clusters; and
train the machine-learning model according to the calibration data, as purged.

19. The medium of claim 18, further comprising instructions that, when executed by the processor, cause the processor to test the machine-learning model using test data to determine the error rate for the machine-learning model.

20. The medium of claim 19, further comprising instructions that, when executed by the processor, cause the processor to one or more of:
(i) determine the error rate for the machine-learning model as being within the error target responsive to the machine-learning model achieving correct results in at least a predefined percentage of the test data; or
(ii) send the machine-learning model to a test subset of the plurality of vehicles, and determine the error rate to be within the error target responsive to receipt, from the test subset of the plurality of vehicles, of test information indicative of the machine-learning model performing more accurately at determining of the locations of the mobile devices as compared to a previous machine-learning model used by the test subset of the plurality of vehicles.
